(19) United States
(12) Patent Application Publication
(10) Pub. No.: US 2021/0297282 A1
(43) Pub. Date: Sep. 23, 2021

(54) USER STATION FOR A SERIAL BUS SYSTEM AND METHOD FOR TRANSMITTING DATA IN A SERIAL BUS SYSTEM

(71) Applicant: Robert Bosch GmbH, Stuttgart (DE)

(72) Inventor: Florian Hartwich, Reutlingen (DE)

(21) Appl. No.: 17/271,475

(22) PCT Filed: Aug. 12, 2019
(86) PCT No.: PCT/EP2019/071597

§ 371 Date: Apr. 13, 2021

(30) Foreign Application Priority Data
Sep. 4, 2018 (DE) 10 2018 214 967.4

(51) Int. Cl. H04L 12/40; H04L 25/49; H04L 25/02; G06F 13/42

(52) U.S. Cl. CPC H04L 12/40032; H04L 25/4917; H04L 2012/40215; G06F 13/4282; H04L 25/0274

(57) ABSTRACT

A user station for a serial bus system. The user station includes a transceiver unit for serially transmitting a message on a bus line to at least one further user station of the bus system or for serially receiving a message from the bus line. The transceiver unit is designed, in the event in which the transceiver unit does not operate as the transmitter of the received message, to generate, if needed, a first or a second bus level on the bus line, and the transceiver unit is designed, in the event in which the transceiver unit operates as the transmitter of the received message, to generate instead of the first or second bus level a third bus level, which is lower than the bus level replaced by the third bus level, but again is one of two bus levels distinguishable in the bus system on the bus line.

### FIELD

The present invention relates to a user station for a serial bus system and to a method for transmitting data in a serial bus system.

### BACKGROUND INFORMATION

In serial bus systems, data that are to be transmitted between user stations are encoded in temporally successive bits and are sent in messages according to a predetermined communication protocol in succession to the bus and thereby transmitted via the bus. The communication protocol establishes at which point in the message which data or bits are encoded. At least one line is used as a transmission medium in hardwired bus systems for transmitting data between the user stations.

For example, certain serial communication protocols including bit arbitration, such as Classical CAN and CAN FD, use a recessive and a dominant bus level as two different bit levels. In this case, the bus levels are selected while taking the transmission medium into account in such a way that the dominant level is able to overwrite the recessive level. Thus, for example, a transmitter which transmits a recessive bit (‘1’) during the arbitration and instead sees a dominant bit (‘0’) on the bus, abandons transmitting and operates only as a receiver for the rest of the ongoing message. The arbitration is won by the transmitter, whose message contains the most leading ‘0’ bits. The winner of the arbitration notices no access conflict for the bus. Thus, a collision and thereby the destruction of transmitted messages does not occur, which is why the arbitration and the following communication occur in a non-destructive manner.

Moreover, the overwriteability of a recessive level with a dominant level allows a bus user, who establishes an error in a message, for example, violation of the bit stuffing rule or checksum error, to overwrite this message with an error detection (error flag).

The transmission medium normally used is, for example, according to the ISO 1898-2 standard, a drilled two-wire line, both line wires of which are interconnected by terminating resistors. Thus, according to the ISO 11898-2 standard, the dominant bus level is actively driven so that a current flows through the terminating resistors. In contrast, the recessive bus level is not driven so that no current flows through the terminal resistors. The differential voltage VDiff between the line wires is therefore close to 0V in the non-driven recessive state.

The problem is that the bits on such a bus having bus levels driven to various degrees are asymmetrically deformed. The edge shift of the bits taking place as a result makes the recessive bits appear shorter than the adjacent dominant bits. At higher bit rates, recessive bits are reduced to such an extent that it is no longer possible to reliably recognize the recessive bits. This asymmetry limits the bit rate for the serial transmission.

A further problem is that the edges, in particular, tend to overshoot from dominant to recessive due to signal reflections. This further restricts the usable portion of the bit time, in particular for sampling, and thus the maximum usable bit rate.

### SUMMARY

It is an object of the present invention to provide a user station for a serial bus system and a method for transmitting data in a serial bus system, which solves the aforementioned problems. A user station for a serial bus system and a method for transmitting data in a serial bus system are, in particular, to be provided, in which both an increase in the bit rate for the transmission of messages as well as a reliable error detection are possible.

The object may be achieved by a user station for a serial bus system including the features of an example embodiment of the present invention. In accordance with an example embodiment of the present invention, the user station includes a transceiver unit for serially transmitting a message on a bus line to at least one further user station of the bus system or for serially receiving a message from the bus line, the transceiver unit being designed, in the event in which the transceiver unit does not operate as the transmitter of the received message, to generate, if needed, a first or a second bus level on the bus line, and the transceiver unit being designed, in the event the transceiver unit operates as a transmitter of the received message, to generate instead of the first or second bus level, a third bus level, which is lower than the bus level replaced by the third bus level, but again is one of two bus levels distinguishable in the bus system on the bus line.

The user station makes it possible that bits be more symmetrically driven on the bus line and that an overshooting, in particular, after signal edges from dominant to recessive, be reduced. This enables higher bit rates and reduces the emission.

The method carried out by the user station may be subsequently inserted into a serial communication protocol, in particular, into the CAN protocol specification with the CAN FD according to the aforementioned standard. For example, the insertion is also possible as an option, which is selectively installed.

Advantageous further embodiments of the user station are described herein.

It is possible that the transceiver unit is designed to generate as a bus level a dominant bus level or a recessive bus level depending on the logic state of the message to be transmitted, the transceiver unit also being designed to transmit the dominant bus level on the bus line by actively driving a differential voltage state, and for the recessive bus level not to drive the differential voltage state on the bus line or to drive it weaker than the dominant bus level.

According to one exemplary embodiment of the present invention, the transceiver unit is designed, in the event that the transceiver unit operates as the transmitter of the received message, to generate the differential voltage state on the bus line for the recessive bus level as a negative voltage state.

In one specific embodiment of the present invention, the transceiver unit may be designed to distinguish a data phase in the message, in which useful data of the message are transmitted, from an arbitration phase, in which it is negotiated which of the user stations operates as the transmitter in the next data phase. In this case, it is possible that the transceiver unit is designed to switch to an operating mode at the start of the data phase, in which the third bus level is generated for a message to be transmitted.

Alternatively, it is possible that the transceiver unit is designed to replace in the data phase of a message to be transmitted both a first recessive bus level with a second recessive bus level as well as a first dominant bus level with a second dominant bus level.

The transceiver unit is optionally designed to reduce at the start of the data phase a first bit time, with which bits are generated in the arbitration phase to a second bit time, with which bits are generated in the data phase.

The user station is potentially designed for a bus system, in which an exclusive, collision-free access of a user station to a bus line of the bus system is at least temporarily ensured. In this case, the transceiver unit may be designed to generate the third bus level only if the transceiver unit has the exclusive collision-free access to the bus line.

The message created or received by the user station may be a CAN message or a CAN FD message.

The above-described user station may be part of a bus system, which also includes a bus line and at least two user stations, which are interconnected via the bus line in such a way that they are able to communicate with one another. In this case, at least one of the at least two user stations is a previously described user station.

The aforementioned object may also achieved by a method for transmitting data in a serial bus system in accordance with an example embodiment of the present invention. In accordance with an example embodiment of the present invention, the method is carried out using a transceiver unit of a user station of the bus system, which is designed for serially transmitting a message on a bus line to at least one further user station of the bus system and for serially receiving a message from the bus line, the method including the step: serially transmitting using the transceiver unit on the bus line in such a way that the transceiver unit, in the event in which the transceiver unit does not operate as the transmitter of a received message, generates, if needed, a first or a second bus level on the bus line, and that the transceiver unit, in the event in which the transceiver unit operates as the transmitter of the received message, generates instead of the first or second bus level, a third bus level, which is lower than the bus level replaced by the third bus level, but is again one of two bus levels distinguishable in the bus system on the bus line.

The above-described method yields the same advantages as were described above with respect to the user station.

Further possible implementations of the present invention also include combinations, not explicitly cited, of features or specific embodiments described above or in the following with reference to exemplary embodiments. In this case, those skilled in the art will also add individual aspects as improvements on or additions to the respective basic form of the present invention.

### BRIEF DESCRIPTION OF THE DRAWINGS

The present invention is described in greater detail below with reference to the figures and based on exemplary embodiments.

FIG. 1 shows a simplified block diagram of a bus system according to a first exemplary embodiment of the present invention.

FIG. 2 shows a diagram for illustrating the structure of messages, which may be transmitted by user stations of the bus system according to the first exemplary embodiment of the present invention.

FIG. 3 shows a representation of one example of a temporal profile of a differential voltage VDIFF of bus signals CAN H and CAN L for a portion of the message in a transceiver unit of the bus system according to the first exemplary embodiment of the present invention.

FIG. 4 shows a representation of one example of a temporal profile of a differential voltage VDIFF of bus signals CAN H and CAN L for a portion of a message in a transceiver unit of a bus system according to a second exemplary embodiment of the present invention.

In the figures, identical or functionally identical elements are, unless otherwise indicated, provided with the same reference numerals.

### DETAILED DESCRIPTION OF EXAMPLE EMBODIMENTS

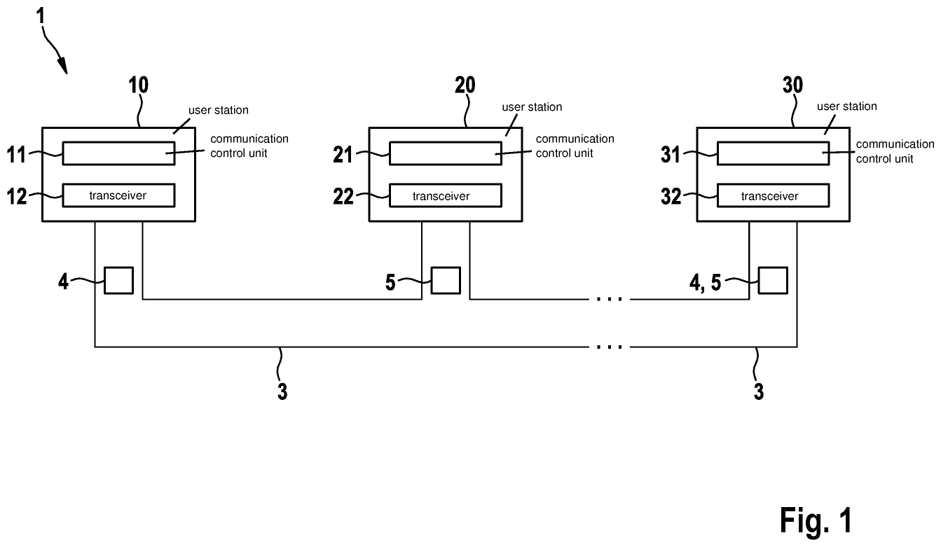

FIG. 1 shows by way of example a serial bus system 1, which may be designed as an arbitrary serial bus system. Bus system 1 is, in particular, a CAN bus system, a CAN FD bus system, a FlexRay bus system, a bus system for Ethernet, a Gigabit Ethernet, etc. Bus system 1 is usable in a vehicle, in particular, in a motor vehicle, in an aircraft, etc., or in the hospital, etc.

Bus system 1 in FIG. 1 has a bus line 3 designed, in particular, as a two-wire line, to which a multitude of user stations 10, 20, 30 are connected. Messages 4, 5 are serially transmittable via bus line 3 in the form of signals between individual user stations 10, 20, 30. User stations 10, 20, 30 are arbitrary devices intended to serially exchange data with one another such as, for example, control units, sensors, display devices, etc., of a motor vehicle. Alternatively, user stations 10, 20, 30 are, for example, computers of a computer network or components of an automation network, in particular, for an industrial plant. User stations 10, 20, 30 are, however, not limited to the specific examples cited.

The present invention is described by way of example below based on the CAN bus system and CAN FD bus system. However, the present invention is not limited thereto; rather the present invention may be applied to an arbitrary serial bus system.

As shown in FIG. 1, user station 10 has a communication control unit 11 and a transceiver unit 12. User station 20, by contrast, has a communication control unit 21 and a transceiver unit 22. User station 30 has a communication control unit 31 and a transceiver unit 32. Transceiver units 12, 22, 32 of user stations 10, 20, 30 are each directly connected to bus line 3, even though this is not illustrated in FIG. 1.

Communication control units 11, 21, 31 are each used to control a communication of respective user station 10, 20, 30 via bus line 3 with another user station of user stations 10, 20, 30, which are connected to bus line 3.

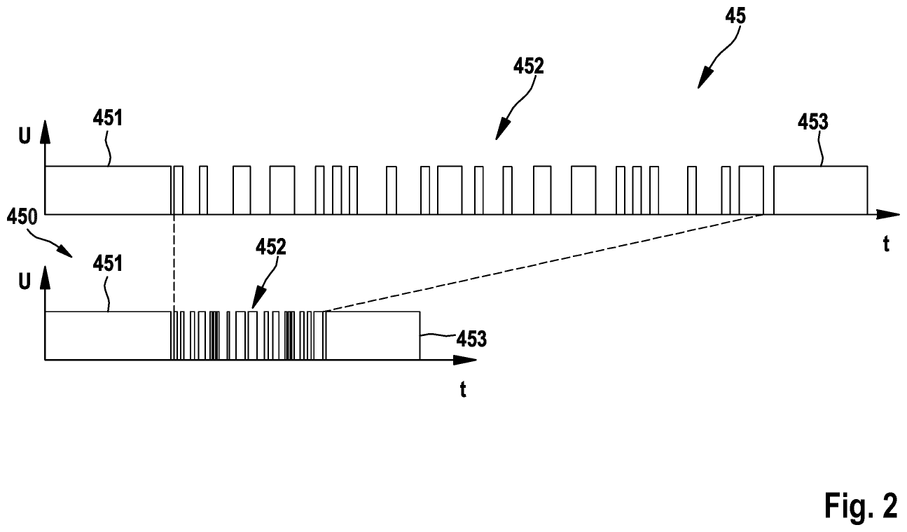

Communication control unit 11 for the example of the CAN bus system may, with the exception of the differences described in greater detail below, be designed as a conventional CAN controller. In this case, communication control unit 11 creates and reads first messages 4, for example modified Classic CAN messages 4. Classic CAN messages 4 are, with the exception of the following described modifications, structured according to the classic basic format, in which a number of up to 8 data bytes may be included in message 4, as shown in the upper portion of FIG. 2.

Communication control unit 21 in FIG. 1, may, for the example of the CAN bus system, with the exception of the differences described in greater detail below, be designed as a conventional CAN FD controller. In this case, communication control unit 21 creates and reads second messages 5, which are modified Classic CAN FD messages 5, for example. Classic CAN messages 5 in this case are, with the exception of the following described modifications, structured on the basis of a CAN FD format, in which a number of up to 64 data bytes may be included in message 5, as shown in the lower portion of FIG. 2. Depending on the need, however, optionally more than 64 data byes are transmittable in message 5.

Communication control unit 31 may be designed for the example of the CAN bus system in order, depending on the need, to provide a modified Classic CAN message 4 or a modified CAN FD message 5 for, or to receive them from, transceiver unit 32. Communication control unit 21 thus creates and reads a first message 4 or second message 5, first and second message 4, 5 differing in terms of their data transmission standard, namely, in this case modified CAN or modified CAN FD.

Thus, transceiver unit 12 may, with the exception of the differences described in greater detail below, be designed as a conventional CAN transceiver. Transceiver unit 22 may, with the exception of the differences described in greater detail below, be designed as a conventional CAN FD transceiver. Transceiver unit 32 may be designed, depending on the need, to provide for, or to receive from, communication control unit 31 messages 4 according to the modified CAN basic format or messages 5 according to the modified CAN FD format.

A formation and then transmission of messages 5 with the modified CAN FD or also at higher data rates than CAN FD is implementable using the two user stations 20, 30.

FIG. 2 shows in its upper portion for message 4 a CAN frame 45 as it is transmitted by transceiver unit 12 or transceiver unit 13, and in its lower portion for message 5 a CAN FD frame 450 as it may be transmitted by transceiver unit 22 or 32. For the CAN communication on bus line 3, CAN frame 45 and CAN FD frame 450 are subdivided basically into two different phases or areas, namely arbitration phases 451, 453 and a data area 452, which in Classical CAN is also referred to as data field or in CAN FD also as data phase 452. The useful data of the CAN FD frame or of message 5 are contained in data phase 452.

In arbitration phase 451, it is negotiated between two or more transmitters that have simultaneously started messages 4, 5, which of the transmitters subsequently has at least temporarily an exclusive, collision-free access to bus line 3. The transmitter that transmits a recessive bit (logic state ‘1’) during the arbitration and sees instead a dominant bit (logic state ‘0’) on the bus or bus line 3, loses the arbitration and becomes the receiver of ongoing message 4 or of message 5. The arbitration is won by the transmitter whose messages 4, 5 contain the most leading ‘0’ bits. The winner of the arbitration notes no access conflict for bus line 3. Thus, no collision results and therefore no destruction of transmitted messages 4, 5, which is why the arbitration and the following communication take place in a non-destructive manner.

As shown in FIG. 2, the bit rate for following data phase 452 is increased in CAN FD at the end of arbitration phase 451 to, for example, 2, 4 8 Mbps as compared to classic CAN. This means that in CAN FD, the bit rate in arbitration phases 451, 453 is lower than the bit rate in data phase 452. In CAN FD, data phase 452 of CAN FD frame 450 is temporally significantly reduced compared to data phase 452 of CAN frame 45.

In a serial bus system without arbitration 451, 453 such as, for example, Ethernet, FlexRay, etc., two data phases 452 directly follow one another.

If one of user stations 10, 20, 30 of FIG. 1 recognizes an error in a message 4, 5, for example, a violation of the bit stuffing rule or an error in the checksum, in particular, CRC error (CRC=cyclic redundancy check), this user station 10, 20, 30 overwrites message 4, 5 recognized as erroneous with an error detection or error flag. The error flag is made up of six dominant bits. All other user stations 10, 20, 30 recognize these six successive dominant bits as a format error or as a violation of the bit stuffing rule, according to which a bit inverse thereto is to be inserted in a message 4, 5 after five identical bits.

An error free message 4, 5 is confirmed by the receivers via an acknowledge bit. For this purpose, the receivers drive a dominant bit in an acknowledge slot recessively transmitted by the transmitter. Except for the acknowledge slot, the transmitter of a message 4, 5 expects to always see on the bus or on bus line 3 the level that the transmitter itself transmits. Otherwise, it recognizes a bit error. In the event of a bit error (apart from the loss of the arbitration) the transmitter considers transmitted messages 4, 5 to be invalid.

Invalid and therefore unsuccessful messages 4, 5 are repeated by the transmitter.

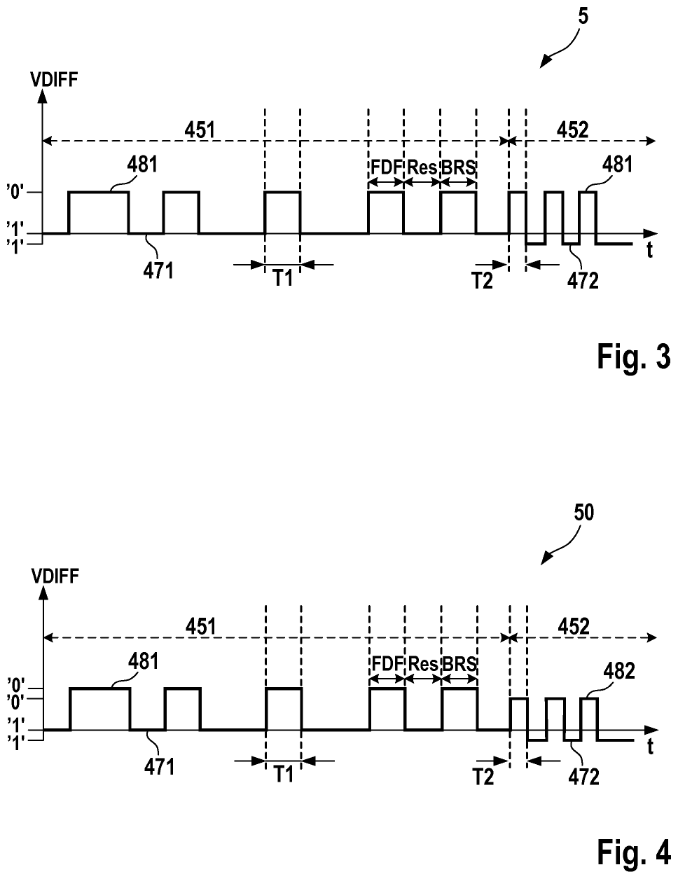

Transceiver units 12, 22, 32 as receivers convert the previously described differential bus levels into logic bit levels, i.e., 0 and 1. As transmitters, transceiver units 12, 22, 32, convert the logic bit levels into the differential bus levels shown in FIG. 3.

FIG. 3 illustrates the transition between arbitration phase 451 and data phase 452 as an example of various communication phases of a message 5 based on a differential voltage VDIFF over time t. For a message 4, the following statements are optionally equally applicable.

Message 5 is generated in arbitration phase 451 with previously described differential bus levels 471, 481 via the two-wire bus line as bus line 3. In other words, differential voltage VDIFF forms differential voltage states for signals CAN H and CAN L, which are generated separately by transceiver units 12, 22, 32 on the two wires of bus line 3.

Recessive bus level 471, which is designated as logic ‘1’ in FIG. 3, but is measurable as a first specific voltage value, is not driven by bus user stations 10, 20, 30, but is determined by a terminating resistor of bus line 3. In contrast, dominant bus level 481 is actively driven. Dominant bus level 481 is represented in FIG. 3 as logic ‘0’, but also measureable as a second specific voltage value. Bus levels 471, 481 are distinguishable from one another as two different bus levels or voltage values for logic ‘1’ and logic ‘0’.

In other words, in the previously described first operating mode of one of transceiver units 12, 22, 32, logic ‘0’ is driven as dominant bus level 481. In the first operating mode for logic ‘1’, i.e., for recessive bus state 471, however, the bus or the voltage state is not driven on bus line 3. The terminal resistors cause recessive bus level 471 to adjust.

As shown in FIG. 3, the bits of message 5 are transmitted in arbitration phase 451 with differential bus levels 471, 481 and with a bit time T1 via bus line 3. In contrast thereto, the bits of message 5 are transmitted in data phase 452 with differential bus level 471, 482 and with a bit time T2 via bus line 3. Bit time T1 is longer than bit time T2. Thus, the bits in data phase 452 are transmitted at a higher or faster bit rate than in arbitration phase 451.

For this purpose, the level for the recessive bus level is switched at the start of data phase 452 of message 5 at the BRS bit, which follows an FDF bit and a Res bit at the end of arbitration phase 451. The bit rate is also switched at the BRS bit. The method described is, however, not bound to one particular message format for the serial transmission.

In data phase 452, the weaker driven negative differential voltage VDIFF corresponding to bus level 472 is then used instead of previous recessive bus level 471. However, bus levels 472, 481 are also distinguishable from one another as two different bus levels or voltage values for logic ‘1’ and logic ‘0’.

Thus, when transmitting message 5 in the previously described second operating mode of one of transceiver units 12, 22, 32, transmitting user station 10, 20, 30 also drives recessive bus level 472, even if weaker than dominant bus level 482. This negative differential voltage VDIFF, a third specific voltage value, is also recognized by existing transceiver units such as, for example, transceiver unit 12 of user station 10 as a recessive bus level, logic ‘1’.

Only the transmitter of a message 5 switches its transceiver unit 12, 22, 32 in data phase 452 from previous bus level 471 for logic ‘1’, i.e., the recessive bus level in arbitration phase 451, to new bus level 472 for logic ‘1’ or from the first operating mode into the second operating mode. In contrast, the receivers of message 5 do need not to switch their bus levels 471.

By way of example of the CAN FD protocol, the suitable point in time for switching recessive bus level 471, 472 of the transmitter would be the start and the end of data phase 452. In arbitration phase 451 of message 5 on the other hand, the normally recessive and dominant bus levels 471, 481 are used as illustrated in FIG. 3 and previously described.

If a receiver of message 5 recognizes an error, non-switched transceiver unit 12, 22, 32, of this receiver may then overwrite weakly driven logic ‘1’ level, i.e., bus level 472 of the transmitter, with a dominant error detection (error flag). Thus, the handling of errors by, for example, the CAN protocol remains possible.

The numerical value for new or second recessive bus level 472 is established as a function of the specified limits for the length of bus line 3, of the number of user stations 10, 20, 30 of bus system 1 and of the bit rate(s) desired for the respective application, in each case with respect to the numerical values for bus level 471, 481 in arbitration phase 451. In CAN, recessive bus levels 471, 472 may, according to the ISO 11898-2, be selected as VDIFF in the range of −1.0V to 0.5V, dominant bus levels 481, 482 as VDIFF in the range of 0.9V to 5V.

Thus, at least one of transceiver units 12, 22, 32 may for a case, in which transceiver unit 12, 22, 32 does not operate as transmitter of received message 5, generate, if needed, first or second bus level 471, 481 on bus line 3. In the event, in which transceiver unit 12, 22, 32 operates, however, as the transmitter of received message 5, transceiver unit 12, 22, 32 generates instead of bus level 471 a third bus level, namely the more minor bus level 472. In the process, third bus level 472 is in turn designed in such a way that bus level 472 and bus level 482 are again two bus levels distinguishable in bus system 1.

Thus, a method is carried out by at least one of user stations 10, 20, 30, more precisely, by one of transceiver units 12, 22, 32, in which transceiver unit 12, 22, 32 is switched during a message 5, so that they use other bus levels 472, 481 in data phase 452, which are less asymmetrical than bus levels 471, 481 in arbitration phase 451.

In this way, faster or higher bit rates in bus system 1 with compatibility to previous user stations 10, 20 are possible. This is also advantageous with a view to a successive expansion and/or renewal of an already existing bus system 1.

FIG. 4 shows with respect to a second exemplary embodiment the area at the end of arbitration phase 451 and at the start of a data phase 452 for a message 50. Here, too, differential voltage VDIFF is again shown over time t with differential symmetrical bus levels 471, 472, 481 via a second two-wire bus line as bus line 3, as previously described with respect to FIG. 3.

In contrast to FIG. 3, a second dominant bus level 482 is also used in the second exemplary embodiment. In this case, bus levels 472, 482 are also distinguishable from one another as two different bus levels or voltage values for logic ‘1’ and logic ‘0’.

For this purpose, the transmitter of a message 50 in data phase 452 optionally drives the transmission level for dominant bits (with a positive differential voltage VDIFF), i.e., a second dominant bus level 482, less intensively than in arbitration phase 451 for first dominant bus level 481. However, second dominant bus level 482 continues to be driven intensively enough that transceiver units 12, 22, 32 of the receiver of message 50 recognize bus level 482 reliably as dominant logic ‘0’. Reduced bus level 482 for logic ‘0’ also reduces the emissions.

Otherwise, the same applies as previously described in conjunction with FIG. 3.

According to a third exemplary embodiment, only dominant bus level 481 in data phase 452 as compared to arbitration phase 451 is lowered by the transmitters of a message 50 to dominant bus level 482, but not recessive bus level 471. Thus, bus levels 471, 481 in this case are used in arbitration phase 451, but bus levels 471, 482 are used in data phase 452.

Otherwise, the same applies as previously described in conjunction with FIG. 3 and FIG. 4.

All previously described embodiments of bus system 1, of user stations 10, 20, 30 and of the method carried out by user stations 10, 20, 30 may be used individually or in all possible combinations. All features of the previously described exemplary embodiments and/or of their embodiment variants and/or of their modifications may, in particular, be arbitrarily combined. In addition or alternatively, the following modifications, in particular, are possible.

Previously described bus system 1 according to the exemplary embodiments is described with reference to a bus system based on the CAN protocol. Bus system 1 according to the exemplary embodiments may, however, also be a different type of serial communication network. It is advantageous, though not necessarily a prerequisite, that in bus system 1 an exclusive, collision-free access of a user station 10, 20, 30 on a shared channel is ensured, at least for particular time periods.

The number and arrangement of user stations 10, 20, 30 in bus system 1 of the exemplary embodiments is arbitrary. User station 10 may, in particular, be omitted in bus system 1. It is possible that one or multiple user stations 10 or 20 or 30 are present in bus system 1.

1-12. (canceled)

13. A user station for a serial bus system, comprising:
a transceiver unit configured to serially transmit a message on a bus line to at least one further user station of the bus system or to serially receive a message, the transceiver unit being configured to, in the event in which the transceiver unit does not operate as a transmitter of a received message, to generate, if needed, a first bus level or a second bus level on the bus line, and the transceiver unit is configured to, in the event in which the transceiver unit operates as the transmitter of the received message, to generate instead of the first bus level or second bus level, a third bus level, which is lower than a bus level replaced by the third bus level, but is one of two bus levels distinguishable in the bus system on the bus line.

14. The user station as recited in claim 13, wherein the transceiver unit is configured to generate as a bus level, a dominant bus level or a recessive bus level depending on a logic state of the message to be transmitted, and the transceiver unit is configured to transmit the dominant bus level on the bus line by actively driving a differential voltage state, and for the recessive bus level, not to drive the differential voltage state or to drive it weaker than the dominant bus level on the bus line.

15. The user station as recited in claim 14, wherein the transceiver unit is configured to, in the event in which the transceiver unit operates as the transmitter of the received message, generate the differential voltage state on the bus line for the recessive bus level as a negative voltage state.

16. The user station as recited in claim 13, wherein the transceiver unit is configured to distinguish a data phase in the message, in which useful data of the message are transmitted, from an arbitration phase, in which it is negotiated which of the user stations operates as the transmitter in a next data phase.

17. The user station as recited in claim 16, wherein the transceiver unit is configured to switch at a start of the data phase to an operating mode, in which the third bus level is generated for a message to be transmitted.

18. The user station as recited in claim 16, wherein the transceiver unit is configured to both to replace a first recessive bus level with a second recessive bus level and replace a first dominant bus level with a second dominant bus level in the data phase of a message to be transmitted.

19. The user station as recited in claim 16, wherein the transceiver unit is designed to reduce at the start of the data phase a first bit time, with which bits in the arbitration phase are generated to a second bit time, with which bits in the data phase are generated.

20. The user station as recited in claim 13, wherein the user station is configured for a bus system, in which an exclusive, collision-free access of a user station to a bus line of the bus system is at least temporarily ensured.

21. The user station as recited in claim 20, wherein the transceiver unit is designed to generate the third bus level only if the transceiver unit has the exclusive, collision-free access to the bus line.

22. The user station as recited in claim 13, wherein the message is a CAN message or a CAN FD message.

23. A bus system, comprising:
a bus line; and
at least two user stations interconnected via the bus line in such a way that they are able to communicate with one another, at least one of the at least two user stations including:
a transceiver unit configured to serially transmit a message on a bus line to at least one further user station of the bus system or to serially receive a message, the transceiver unit being configured to, in the event in which the transceiver unit does not operate as a transmitter of a received message, to generate, if needed, a first bus level or a second bus level on the bus line, and the transceiver unit is configured to, in the event in which the transceiver unit operates as the transmitter of the received message, to generate instead of the first bus level or second bus level, a third bus level, which is lower than a bus level replaced by the third bus level, but is one of two bus levels distinguishable in the bus system on the bus line.

24. A method for transmitting messages in a serial bus system including a transceiver unit, which is configured to serially transmit a message on a bus line to at least one further user station of the bus system and to serially receive a message from the bus line, the method comprising:
serially transmitting using the transceiver unit on the bus line in such a way that the transceiver unit, in the event in which the transceiver unit does not operate as the transmitter of a received message, generates, if needed, a first bus level or a second bus level on the bus line, and the transceiver unit, in the event in which the transceiver unit operates as the transmitter of the received message generates instead of the first bus level or the second bus level, a third bus level which is lower than a bus level replaced by the third bus level, but is one of two bus levels distinguishable in the bus system on the bus line.
